(19) United States
(12) Patent Application Publication
(10) Pub. No.: US 2008/0209992 A1
(43) Pub. Date: Sep. 4, 2008

(54) PRESSURE SENSOR AND PRESSURE CONTROL SYSTEM

(75) Inventor: Yasuhiro MURAYAMA, Takahama-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/024,295

(22) Filed: Feb. 1, 2008

(30) Foreign Application Priority Data
Feb. 2, 2007 (JP) 2007-024638

(51) Int. Cl. G01M 15/00

(52) U.S. Cl. 73/114.43

(57) ABSTRACT

A pressure sensor comprises a reference voltage generating part which generates a predetermined voltage as a reference and a sensing part which senses the pressure of the detection object and outputs a signal according to the pressure therein. The outputs of the reference voltage generating part and the sensing part are inputted to a tri-state buffer. Switch terminals of the tri-state buffers are connected with the command line. When the command signal is applied to the command line, either one of the output of the reference voltage generating part or the sensing part is outputted to the output line.

### CROSS-REFERENCE TO RELATED APPLICATION

This application is based on and claims the benefit of priority from earlier Japanese Patent Application No. 2007-024638 filed Feb. 2, 2007, the description of which is incorporated herein by reference.

### BACKGROUND OF THE INVENTION

1. Technical field of the Invention

The present invention relates to a pressure sensor for detecting pressure in an accumulator, in which fuel is supplied from a fuel pump for storage in the accumulator, with the pressure being kept at a high level, and the stored fuel is supplied to fuel injection valves in an internal combustion engine. The present invention also relates to a pressure control system for carrying out feedback control with the operation of the fuel pump to bring a detected signal derived from the pressure sensor in conformity with a target pressure.

2. Description of the Related Art

Common-rail type diesel engines have been known, which are provided with an accumulator (common rail) shared between fuel injection valves of individual cylinders, to supply high-pressure fuel to each of the fuel injection valves. Such a common-rail type diesel engine is free to control the fuel pressure in the common rail according to the operational conditions of the engine and thus is free to control the pressure of the fuel supplied to each of the fuel injection valves.

Specifically, an appropriate fuel pressure in a common rail is set as a target pressure on the basis, in general, of a manipulated variable of an accelerator pedal and a commanded injection quantity over a fuel injection valve. Feedback control is carried out so that a detected signal derived from a pressure sensor for detecting the fuel pressure in the common rail follows up the target pressure. Thus, the fuel pressure in the common rail can be desirably controlled.

Malfunction occurring in the pressure sensor may prevent acquisition of information on an accurate fuel pressure in the common rail. This may also prevent appropriate feedback control from being carried out and thus may prevent the fuel pressure in the common rail from following up the target pressure.

To take a measure for the issue mentioned above, Japanese Patent Application Laid-Open Publication No. 2003-222045, for example, suggests detecting malfunction of a pressure sensor on the basis of the pressure in the common rail after the expiration of a predetermined time interval from when the diesel engine is stopped. Specifically, after the expiration of a predetermined time interval, the pressure in the common rail is considered to have been reduced to the level of the atmospheric pressure. Malfunction can thus be determined as having occurred on the basis of the fact that the pressure in the common rail is offset from the atmospheric pressure.

As a pressure becomes higher, a pressure sensor indicates a higher value of the pressure in the form of a detection signal. Accordingly, when an electrical resistance is accidentally applied to the lines electrically connecting the pressure sensor and a control unit, the output of the pressure sensor is lowered by an amount equivalent to the voltage drop caused by the electrical resistance. As a result, a detected signal of the pressure sensor becomes lower than an actual pressure value. Also, intentional increase of a resistance of the lines connecting the pressure sensor and the control unit will allow the detected signal of the pressure sensor to be lower than the actual pressure value. In these cases, feedback control is performed so that the fuel pressure in the common rail will be higher than a target pressure. Under the circumstances, a fuel pressure lower than the actual fuel pressure is erroneously regarded as being the fuel pressure in the common rail, based on which the fuel injection valves are operated. As a result, the injection quantity of the diesel engine may become excessively large to cause various disadvantages, such as deteriorations in the output characteristics and in the reliability of the diesel engine.

Japanese Patent Application Laid-Open Publication No. 2003-222045 mentioned above also suggests an approach of detecting malfunction of a pressure sensor in a region where detected voltage is low. Taking this approach, the output voltage of the pressure sensor will be necessarily low when malfunction is detected, and thus an offset amount of a detected signal due to the increase of the electrical resistance in each of the cases mentioned above may also be small. This may prevent accurate detection of the malfunction. The approach suggested in the above literature may erroneously determine the pressure sensor as having malfunction in the case where the pressure in the common rail has not yet been reduced to the level of the atmospheric pressure.

If no malfunction can be determined as having occurred, no appropriate measure can be taken for the malfunction that might have occurred.

### SUMMARY OF THE INVENTION

The present invention has been made in order to solve the issue is described above, and has as its object to provide a pressure sensor and a pressure control system, which can appropriately cope with the malfunction of the pressure sensor.

Means for solving the issue mentioned above as well as the advantages of the means will be described below.

A mode of the pressure sensor of the present invention comprises: detected signal outputting means that outputs a signal according to the pressure in the accumulator, reference signal outputting means that outputs a signal which serves as a standard signal irrespective of the pressure in the accumulator, and selecting means that outputs alternatively either of output of the detected signal outputting means or output of the reference signal outputting means according to an externally given command.

In the pressure sensor of the present invention provided with the reference signal outputting means, variation in a detected reference signal is regarded as indicating the occurrence of malfunction in the pressure sensor due, for example, to variation in the resistances in the lines connected to the pressure sensor, which malfunction may cause variation in the output signals of the pressure sensor. Thus, on the basis of the output of the reference signal outputting means, an appropriate determination can be made as to whether or not malfunction has occurred, that is, whether or not a signal outputted from the detected signal outputting means has offset from the level corresponding to the actual pressure.

In the mode of the pressure sensor, the output signal of the detected signal outputting means becomes smaller value as the pressure inside of the accumulator becomes higher.

When malfunction occurs, or when the resistance is increased in the line, for example, to which an output signal of the pressure sensor is outputted, the level of the output signal of the pressure sensor becomes lower by an amount of the voltage drop due to the increase of the resistance. In this regard, in the pressure sensor of the present invention, the value of the output signal is adapted to become smaller as the internal pressure becomes higher. Accordingly, when malfunction occurs, a detected signal of the pressure sensor becomes larger than a value corresponding to the actual pressure. In this case, since the actual pressure is estimated to be excessively large, the inconveniences that would be ascribed to an excessively small estimation of the actual pressure can be avoided.

Further in the mode of the pressure sensor, the pressure sensor is disposed in a fuel supply system that feedback control the fuel pump so that the detected value of the pressure sensor follows up a target pressure.

In the pressure sensor of the present invention, the detected signal of the pressure sensor is subjected to feedback control so as to be in conformity with a target pressure. Thus, the control accuracy of the pressure in an accumulator relies on the accuracy of the detected signal of the pressure sensor. In the pressure sensor of the present invention, information on the accuracy of the detected signal of the pressure sensor can be supplied by having a reference signal outputted. In this way, the deteriorating controllability of the feedback control can be grasped.

A mode of the pressure control system of the present invention comprises: switching means that switches the output of the pressure sensor to the output of the reference signal outputting means by operating the selecting means, and determining means that determines the existence of the abnormalities of detected value of the pressure sensor based on the output of the reference signal outputting means.

In the pressure control system of the present invention, the output of the pressure sensor can be switched to the output of the reference signal outputting means, and on the basis of the switched output, the detected signal of the pressure sensor can be determined as to whether or not it is at an abnormal level. Thus, the deteriorating controllability of the feedback control can be grasped, and thus an appropriate measure can be taken for the deterioration.

In the mode of the pressure control system, the switching means changes the output of the pressure sensor to the output of the reference signal outputting means when the internal combustion engine is in a stopped state.

During the operation of the internal combustion engine, the detected signal derived from the pressure sensor for the fuel pressure in the accumulator has generally been utilized. Under such circumstances, it is difficult to switch the output of the pressure sensor to the output of the reference signal outputting means. In this regard, the pressure sensor of the present invention can appropriately perform the switching, because switch to the reference signal outputting means is performed during stoppage of the internal combustion engine.

Another mode of the pressure sensor of the present invention comprises; detected signal outputting means, wherein an output signal of the detected signal outputting means becomes smaller value as the pressure inside of the accumulator becomes higher.

When malfunction occurs, or when the resistance is increased in the line, for example, to which an output signal of the pressure sensor is outputted, the level of the output signal of the pressure sensor becomes lower by an amount of the voltage drop due to the increase of the resistance. In this regard, in still another mode of the pressure sensor of the present invention, the value of the output signal is adapted to become smaller as the internal pressure becomes higher. Accordingly, when malfunction occurs, a detected signal of the pressure sensor becomes larger than a value corresponding to the actual pressure. In this case, since the actual pressure is estimated to be excessively large, the inconveniences that would be ascribed to an excessively small estimation of the actual pressure can be avoided.

In another mode of the pressure sensor, the pressure sensor is disposed in a fuel supply system that feedback control the fuel pump so that the detected value of the pressure sensor follows up a target pressure.

In the pressure sensor of the present invention, the detected signal of the pressure sensor is subjected to feedback control so as to follow up a target pressure. Therefore, when the detected signal of the pressure sensor is lower than a value corresponding to the actual pressure, the pressure in the accumulator may possibly be controlled higher than the target pressure. Meanwhile, a main factor of causing malfunction, or of allowing the detected signal of the pressure sensor to be considerably offset from a value corresponding to the actual pressure, is the increase of the resistance in a line, for example, to which the output signal of the pressure sensor is outputted. In this case, the increase of the resistance makes the level of the output signal low. In this regard, the actual pressure is estimated to be excessively large in the pressure sensor of the present invention at the occurrence of malfunction of lowering the level of the output signal. Accordingly, the pressure in the accumulator can be prevented from being controlled higher than the target pressure.

### BRIEF DESCRIPTION OF THE DRAWINGS

In the accompanying drawings,

FIG. 1 is a schematic diagram generally illustrating a configuration of an engine system according to a first embodiment of the present invention;

FIGS. 2A and 2B each is a block diagram illustrating a configuration of a pressure sensor according to the first embodiment;

FIG. 3 is a graph illustrating output characteristics of the pressure sensor according to the first embodiment;

FIG. 4 is a flow diagram illustrating a procedure of determining the occurrence of malfunction on the basis of a detected signal of the pressure sensor according to the first embodiment; and

FIG. 5 is a graph illustrating output characteristics of a pressure sensor according to a second embodiment of the present invention.

### DETAILED DESCRIPTION OF THE PREFERRED EMBODIMENTS

### First Embodiment

With reference to the accompanying drawings, hereinafter will be described a first embodiment in which a fuel injection control system associated with the present invention is applied to a fuel injection control system of a common-rail type diesel engine mounted on a vehicle.

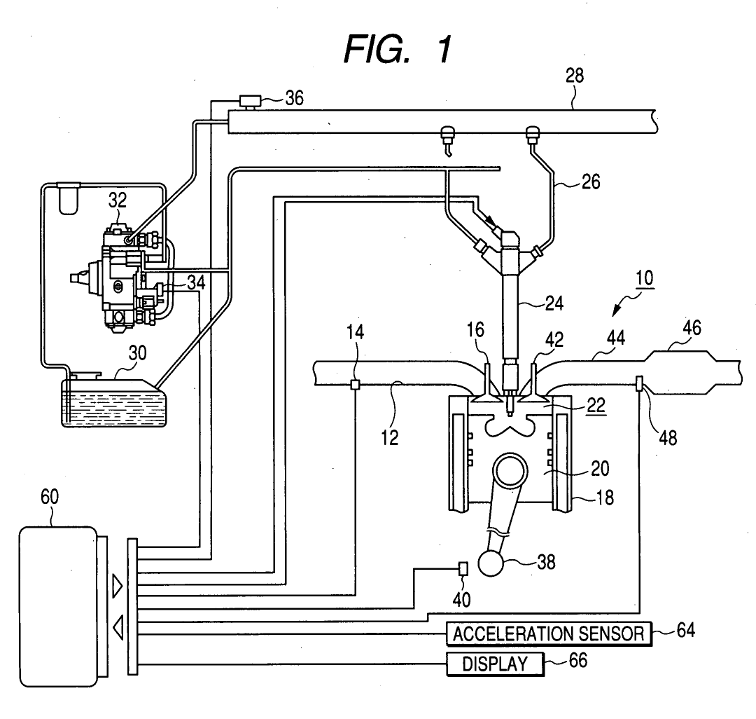

FIG. 1 is a schematic diagram generally illustrating a configuration of an engine system according to the present embodiment. As shown in the figure, a diesel engine 10, which is an internal combustion engine, includes an airflow meter 14 provided upstream of is an intake passage 12, for detecting an amount of intake air. The intake passage 12 communicates with a combustion chamber 22 through an opening operation of an intake valve 16, the combustion chamber 22 being defined by a cylinder block 18 and a piston 20. A fuel injection valve 24 is disposed in the combustion chamber 22 with an end portion of the former being projected into the latter, so that fuel can be injected and supplied to the combustion chamber 22.

Fuel is supplied to the fuel injection valve 24 from a common rail 28 via a high-pressure fuel passage 26. The common rail 28 serves as an accumulator shared between individual cylinders, for storing fuel pressurized and supplied (pumped) from a fuel tank 30 by a fuel pump 32, with the pressure of the fuel being kept at a high level. The fuel pump 32 is provided with a metering valve 34 for adjusting an amount of fuel pumped to the common rail 28. Thus, the fuel pressure in the common rail 28 is adapted to be controllable by adjusting pumping speed. The common rail 28 is provided with a pressure sensor 36 for detecting pressure in the common rail 28.

Upon injection of fuel into the combustion chamber 22, the combustion chamber 22 is compressed to have the fuel self-ignited and energy is generated. This energy is extracted through the piston 20 in the form of rotational energy for an output shaft (crank shaft 38) of the diesel engine 10. In the vicinity of the crankshaft 38, a crank angle sensor 40 is disposed for detecting rotation angle of the crankshaft 38.

After injecting the fuel in the common rail 28 into the combustion chamber 22 through the fuel injection valve 24 to cause combustion, the gas used for the combustion is discharged as an exhaust gas to an exhaust passage 44 with an opening operation of an exhaust valve 42. The exhaust passage 44 is provided with an after-treatment system 46 consisting of a catalyst, a DPF (diesel particulate filter) and the like for cleaning the exhaust gas. The exhaust passage 44 is also provided with an air-fuel ratio sensor 48 for detecting an air-fuel ratio on the basis of an oxygen concentration in the exhaust gas.

An electronic control unit (ECU 60) includes a microcomputer. The ECU 60 controls the output characteristics of the diesel engine 10 by extracting the outputs of the individual sensors in the engine system and an output of an acceleration sensor 64 for detecting an operated variable of the accelerator pedal, and by operating the individual actuators in the diesel engine 10, such as the fuel injection valve 24 and the metering valve 34, on the basis of the extracted outputs. In particular, the ECU 60 carries out feedback control so that a detected signal of the pressure sensor 36 follows up a target value (target pressure). It should be appreciated that the target pressure is set on the basis of a command value for an injection quantity (commanded injection quantity) for the fuel injection valve 24 and an engine speed, and that the commanded injection quantity is set based on an operated variable of the accelerator pedal and the engine speed.

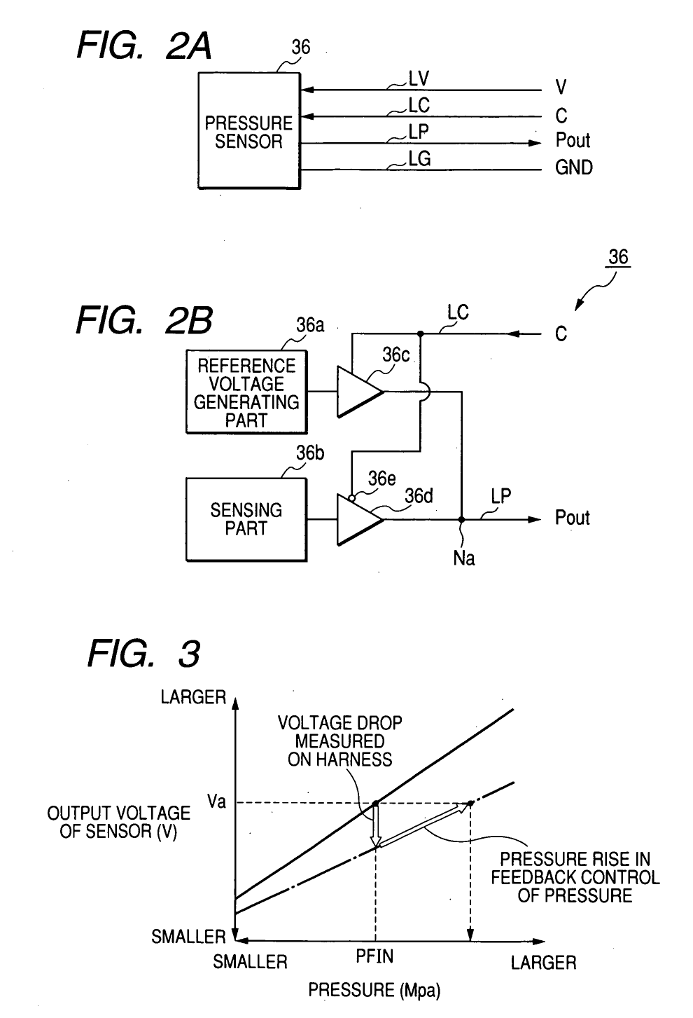

FIGS. 2A and 2B each illustrate the pressure sensor 36. As shown in FIG. 2A, the pressure sensor 36 is connected with four lines, i.e. a power supply line LV for supplying power from the ECU 60, a command line LC for outputting a command signal C to the pressure sensor 36 from the ECU 60, an output line LP for outputting a detected signal for pressure, and a ground line LG connected to a grounding terminal of the ECU 60.

FIG. 25 illustrates an inner configuration of the pressure sensor 36. As shown, the pressure sensor 36 includes a reference voltage generating part 36a, which is a reference signal outputting means, and a sensing part 36b, which is a detected signal outputting means. The reference voltage generating part 36a generates a predetermined voltage as a reference. The sensing part 36b has strain gauges (not shown) and the like and senses pressure. The output of the reference voltage generating part 36a is inputted to a tri-state buffer 36c and the output of the sensing part 36b is inputted to a tri-state buffer 36d. Output terminals of the tri-state buffers 36c and 36d both output signals to a node Na which is connected to the output line LP, The reference voltage generating part 36a, the sensing part 36b as well as the tri-state buffers 36c and 36d are supplied with power via the supply power line LV, and operated by the voltage between the power supply line LV and the ground line LG. Indication of the connecting relation with the power supply line LV and the ground line LG has been omitted from FIG. 2A.

Switch terminals of the tri-sate buffers 36c and 36d are connected with the command line LC. In particular, in order to input signals, which are logically inverted to each other, to the switch terminals of the tri-state buffers 36c and 36d, the tri-state buffer 36d is connected with the command line LC via an inverter 36e. In this way, when the command signal C is applied to the command line LC, the command signal C is Inputted to the switch terminal of the tri-state buffer 36c, while a logically inverted signal of the command signal C is inputted to the switch terminal of the tri-state buffer 36d. Thus, when the command signal C is a logic “L” an output signal (detected signal) of the sensing part 36b is outputted to the output line LP, and when the command signal C is a logic “H”, an output signal (detected signal) of the reference voltage generating part 36a is outputted to the output line LP.

In the configuration described above, the command signal C is normally rendered to be the logic “L” to acquire a pressure in the common rail 28 by the pressure sensor 36. On the other hand, by rendering the command signal C to be the logic “H”, the output of the reference voltage generating part 36a can be selected for the issuance of an output signal (detected signal). The detected signal of the pressure outputted from the pressure sensor 36 with the selection of the reference voltage generating part 36a can help determine the occurrence of malfunction in the pressure sensor 36, which is likely to have been caused by malfunction in the communication systems such as the output line LP and the power supply line LV, between the pressure sensor 36 and the ECU 60. A specific description on this is provided below.

FIG. 3 is a graph illustrating the output characteristics of the pressure sensor 36 of the present embodiment. As indicated by a solid line in the figure, the pressure sensor 36 of the present embodiment in a normal state has the output characteristics of the output voltage being increased as the pressure to be detected becomes higher. A dashed-dotted line in the figure indicates the output characteristics of a case where the resistance of the output line LP or the power supply line LV is Increased. In the latter case, the output voltage of the pressure sensor 36 (more precisely, the output voltage of the pressure sensor 36 detected by the ECU 60) is reduced compared to the normal state. Thus, in spite of the fact that the pressure in the common rail 28 is at a level of a target pressure PFIN, the output voltage of the pressure sensor 36 becomes lower than a voltage value Va corresponding to the target pressure PFIN. Accordingly, the ECU 60 erroneously recognizes the pressure in the common rail 28 as being lower than the target pressure PFIN and operates the fuel pump 32 to raise the pressure in the common rail 28. Thus, the execution of the feedback control to bring the detected signal of the pressure sensor 36 in conformity with the target pressure PFIN, allows the actual pressure to be controlled higher than the target pressure PFIN.

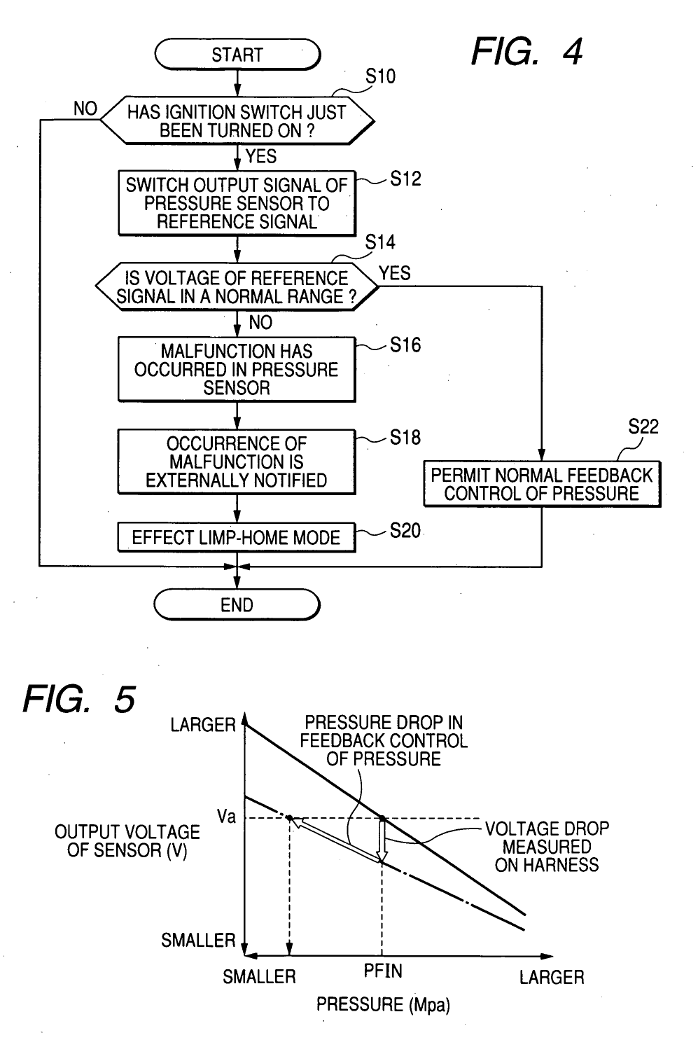

In order to avoid such a situation, when the actual pressure to be controlled becomes higher than the target pressure PFIN, the present embodiment is adapted to render the command signal C to be the logic “H” to select the reference voltage generating part 36a, for the issuance of an output signal (detected signal). On the basis of the detected signal derived from the pressure sensor 36 with the selection of the reference voltage generating part 36a, a determination can be made as to the occurrence of malfunction in the pressure sensor 36. FIG. 4 is a flow diagram illustrating a procedure for making a determination on the occurrence of malfunction.

In a series of processes in the procedure, it is determined, at step S10, whether or not an ignition switch has just been turned on. In other words, it is determined at this step whether or not the diesel engine 10 is in a stopped state. If the diesel engine 10 is determined as being in a stopped state, the output of the pressure sensor 36 is switched, at step S12 (a switching means), so that a reference signal is issued. In other words, the command signal C to be outputted to the command line LC is rendered to be the logic “H”, so that an output signal of the reference voltage generating part 36a can be applied to the output line LP. At the following step S14 Ca determining means), it is determined whether or not the reference signal inputted to the ECU 60 via the output line LP has a voltage value falling within a normal range. It should be appreciated that the normal range is determined in advance on the basis, for examples of an output voltage of the reference voltage generating part 36a and an amount of voltage drop caused by a reference resistance of the output line LP. Preferably, the output voltage of the reference voltage generating part 36a is set at a value which enables the ECU 60 to accurately detect the change in the amount of voltage drop of the power supply line LV or the output line LP due to the change in the resistances thereof, under the condition where the voltage applied to the power supply line LV is at a normal level.

If a negative determination is made at step S14, it is determined, at step S16, that the detected signal (inputted to the ECU 60 via the output line LP) of the pressure sensor 36 is at an abnormal level. Specifically, when the reference voltage does not fall within the normal range, the amount of voltage drop in the output line LP is considered to be beyond the scope of the assumption. Accordingly, if the output of the pressure sensor 36 is switched to the sensing part 36b, the value inputted to the ECU 60 via the output line LP is considered to be significantly offset from the value corresponding to the actual pressure to be detected in the common rail 28. Thus, it is determined, at step S16, that the detected signal of the pressure sensor 36 is at an abnormal level.

At the subsequent step S18, information on the occurrence of malfunction is outputted to a display 66 shown in FIG. 1 on the basis of the determination at step S16. The display 66 can be disposed on an instrument panel, for example, of the vehicle concerned. Thus, the information on the malfunction of the pressure sensor 36 can be promptly notified to the user. At step S20, a limp-home mode is affected in which the diesel engine 10 is operated while the output torque of the diesel engine 10 is being limited, so that the vehicle can travel at low speed. For example, in the limp-home mode, the fuel pump 32 is operated in an open-loop fashion to limit the fuel discharge, or a manipulated variable (e.g. command value of an injection time interval) of the fuel injection valve 24 is limited to limit the Injection quantity. Thus, irrespective of the malfunction of the pressure sensor 36, the vehicle is allowed to travel, while preventing the output of the diesel engine 10 from becoming excessively large.

On the other hand, if an affirmative determination is made at step S14, control proceeds to step S22, where the feedback control is permitted to be carried out as usual to bring the pressure in the common rail 28 in conformity with the target pressure. In this case, the command signal C outputted to the command line LC is rendered to be the logic “L” to switch the output of the pressure sensor 36 to the output of the sensing part 36b.

It should be appreciated that, if a negative determination is made at step S10, or when completing the processes of steps S20 and S22, the series of processes is once ended.

As described in detail in the above, the following advantages can be obtained from the present embodiment.

(1) The pressure sensor 36 has been configured with the sensing part 36b for outputting a signal according to the pressure in the common rail 28, the reference voltage generating part 36a for outputting an output signal that serves as a reference, irrespective of the level of the pressure, and the tri-state buffers 36c and 36d for selectively having either the sensing part 36b or the reference voltage generating part 36a outputted a signal in response to an externally as given command. Thus, the pressure sensor 36 can be appropriately determined as to its malfunction that the detected signal thereof is offset from a value corresponding to the actual pressure, on the basis of whether or not an output signal of the reference voltage generating part 36a falls in a normal region.

(2) The pressure sensor 36 of the present embodiment has been applied to a fuel supply system for operating the fuel pump 32, in order that feedback control can be carried out for bringing a detected signal derived from the pressure sensor 36 in conformity with a target pressure. Accordingly, the control accuracy of the pressure in the common rail 28 necessarily relies on the accuracy of the detected signal of the pressure sensor 36. In this regard, owing to the provision of the reference voltage generating part 36a, the deteriorating controllability of the feedback control can be grasped, leading to preventing the occurrence of a situation where the pressure. In the common rail 28 is excessively offset from a target value.

(3) The occurrence of malfunction in the pressure sensor 36 has been determined on the basis of the detected signal derived from the pressure sensor 36, that is, on the basis of the output from the reference voltage generating part 36a. Thus, the deteriorating controllability of the feedback control can be grasped, the deterioration being caused by the fact that the detected signal derived from the pressure sensor 36 is at an abnormal level. In this way, appropriate measure can be taken for the deterioration.

(4) When the diesel engine 10 is in a stopped state, the output of the pressure sensor 36 has been switched to the output of the reference voltage generating part 36a. Thus, the operation of switching the pressure sensor 36 will not interfere with the process of detecting pressure for the feedback control, for example, of the pressure in the common rail 28. In particular, retrieval of the output from the reference voltage generating part 36a immediately before starting the diesel engine 10 may allow for more appropriate measure for the malfunction of the pressure sensor 36. On the other hand, for example, in the case where the output of the reference voltage generating part 36a is inputted to the ECU 60 as its after-processing immediately after stopping the operation of the diesel engine 10, it is difficult to promptly cope with the malfunction or the like of the output line LP in the time interval from the stop to the start of the diesel engine 10.

### Second Embodiment

With reference to the drawings, hereinafter will be described a second embodiment of the present invention, focusing on the differences from the first embodiment.

In the second embodiment, the identical or similar components to those in the first embodiment are given the same references for the sake of simplification or omission of explanation.

FIG. 5 is a graph illustrating the output characteristics of the pressure sensor 36 according to the present embodiment.

As indicated by a solid line in the figure, the pressure sensor 36 of the present embodiment in a normal state has the output is characteristics of decreasing the output voltage as the pressure to be detected becomes higher. These output characteristics can be realized, for example, by providing a configuration in which the output of the sensing part 36b shown in FIG. 2 is inputted to an inverting amplifier circuit to permit the output of the inverting amplifier circuit to serve as the output of the pressure sensor 36. Alternatively, for example, providing strain gauges and a differential amplifier circuit may configure the pressure sensor 36, so that the output of the strain gauges is inputted to a pair of input terminals of the differential amplifier circuit to permit the output of the differential amplifier circuit to serve as the output of the sensing part 36b. With this configuration, the output characteristics can be realized by reversing the signal inputted to the pair of input terminals of the differential amplifier circuit from that of the first embodiment. Alternatively, providing bridge-connected gauges, as disclosed in Japanese Patent Laid-Open No. 09-232595, for example, so may configure the sensing part 36b. In this configuration, the output characteristics can be realized by adjusting resistances of these gauges.

A dashed-dotted line in the figure indicates output characteristics in a case where the output voltage of the sensing part 36b, which is inputted to the ECU 60, is lowered with the increase, for example, of the resistance of the output line LP. In this case, the voltage outputted by the pressure sensor 36 becomes lower than a value estimated from the actual pressure. This means that the detected signal derived from the pressure sensor 36 is higher than the value corresponding to the actual pressure. Therefore when the pressure detected by the pressure sensor 36 is controlled at a level of the target pressure PFIN, the actual pressure in the common rail 28 is controlled to have a value lower than the target pressure PFIN. Accordingly, without being provided with the reference voltage generating part 36a as in the first embodiment, the pressure in the common rail 28 can be prevented from being controlled at an excessively high level due to the decrease in the detected signal of the pressure sensor 36, which is inputted to the ECU 60.

The setting shown in FIG. 5 is effective because, in general, the voltage of the output line LP has a tendency of being reduced due, for example, to the contact failure at the line-connecting portion thereof or due to the deterioration of the line.

As described above, the present embodiment has the following advantages.

(5) The output of the pressure sensor 36 has been set so that the output signal may have a smaller value as the pressure becomes higher. Thus, the pressure in the common rail 28 can be prevented from being subjected to feedback control at an excessively high level, under the condition where the detected signal of the pressure sensor 36 is offset from the value corresponding to the actual pressure by, for example, the increase of the resistance in the output line LP or the power supply line LV.

(Modifications)

The embodiments described above may be modified as follows.

In the second embodiment, providing the reference voltage generating part 36a and the tri-state buffers 36c and 36d may configure the pressure sensor 36. Thus, an appropriate determination can be made as to malfunction of the pressure sensor 36, and thus the user can be promptly notified accordingly. Moreover, in the case where the pressure sensor 36 has the output characteristics shown in FIG. 5, a limp-home mode may be affected to feed back the detected signal of the pressure sensor 36 to a target pressure, rather than performing an open-loop operation of the fuel pump 32. This may also prevent the pressure in the common rail 28 from being controlled at an excessively high level. In this case, since an amount of fuel injected via the fuel injection valve 24 becomes lower than a commanded injection quantity, the output torque of the diesel engine 10 may also necessarily be limited.

In the first embodiment, the determination as to malfunction of the pressure sensor 36 has been made on the basis of its detected signal, i.e. on the basis of the output of the reference voltage generating part 36a. When the pressure sensor 36 is determined as being malfunctioning, the limp-home mode has been affected. Alternatively, for example, a variation of the resistance in the output line LP or the power supply line LV may be estimated on the basis of the difference between the value inputted to the ECU 60 as the output of the reference voltage generating part 36a and a value of a reference voltage generated by the reference voltage generating part 36a, so that an amount of correction of the detected signal of the pressure sensor 36 can be calculated on the basis of the estimated variation of the resistance. Thus, irrespective of the variation in the resistance of the output line LP or the power supply line LV, an accurate value can be acquired for the pressure in the common rail 28 on the basis of the detected signal of the pressure sensor 36. This may lead to high-accuracy feedback control of the pressure in the common rail 28, for achieving a target pressure.

In the first embodiment, the timing for acquiring the output of the reference voltage generating part 36a may not necessarily be immediately before starting the diesel engine 10 but may, for example, be immediately after stopping the diesel engine 10. Alternatively, in the case where the ECU 60 has a timer therein to temporarily start the ECU 60 after the expiration of a predetermined time interval, the output of the reference voltage generating part 36a may be acquired at the time of this temporal starting of the ECU 60. Alternatively, the output of the reference voltage generating part 36a may be acquired between sampling periods of the detected signal of the pressure sensor 36 during the feedback control of the pressure in the common rail 28.

The pressure in the common rail 28 may be subjected to feedforward control, rather than feedback control. In this case as well, when the pressure in the common rail 28 is offset from the actual pressure, application of the first embodiment is effective to cope with the deterioration of accuracy in setting a manipulated variable of the fuel injection valve 24 in conformity with a commanded injection quantity. The second embodiment may alternatively be applied to this case, so that an amount of fuel injected from the fuel injection valve 24 can be made smaller than a commanded injection quantity when the pressure sensor 36 is determined as having malfunction on the basis of the detected signal. Thus, the output torque of the diesel engine 10 can be prevented from becoming excessively large.

Alternative to a compression-ignition internal combustion engine, such as the diesel engine 10, a cylinder-injection gasoline engine, for example, may be usable.

What is claimed is:

1. A pressure sensor for detecting pressure in an accumulator, wherein fuel is supplied from a fuel pump for storage in the accumulator, with the pressure being kept at a high level, and the stored fuel is supplied to fuel injection valves in an internal combustion engine, comprising:
detected signal outputting means that outputs a signal according to the pressure in the accumulator,
reference signal outputting means that outputs a signal which serves as a standard signal irrespective of the pressure in the accumulator, and
selecting means which outputs alternatively either of output of the detected signal outputting means or output of the reference signal outputting means according to an externally given command.

2. The pressure sensor of claim 1, wherein the pressure sensor is disposed in a fuel supply system that feedback control the fuel pump so that the detected value of the pressure sensor follows up a target pressure.

3. The pressure sensor of claim 1, wherein the output signal of the detected signal outputting means becomes smaller value as the pressure inside of the accumulator becomes higher.

4. The pressure sensor of claim 3, wherein the pressure sensor is disposed in a fuel supply system that feedback control the fuel pump so that the detected value of the pressure sensor follows up a target pressure.

5. A pressure control system for carrying out feedback control with the operation of the fuel pump to bring a detected signal derived from the pressure sensor in conformity with a target pressure, comprising:
switching means that switches the output of the pressure sensor to the output of the reference signal outputting means by operating the selecting means, and
determining means that determines the existence of the abnormalities of detected value of the pressure sensor based on the output of the reference signal outputting means.

6. The pressure control system of claim 5, wherein the switching means changes the output of the pressure sensor to the output of the reference signal outputting means when the internal combustion engine is in a stopped state.

7. A pressure sensor for detecting pressure in an accumulator, wherein fuel is supplied from a fuel pump for storage in the accumulator, with the pressure being kept at a high level, and the stored fuel is supplied to fuel injection valves in an internal combustion engine, comprising:
detected signal outputting means, wherein an output signal of the detected signal outputting means becomes smaller value as the pressure inside of the accumulator becomes higher.

8. The pressure sensor of claim 7, wherein the pressure sensor is disposed in a fuel supply system that feedback control the fuel pump so that the detected value of the pressure sensor follows up a target pressure.
